(19) United States
(12) Patent Application Publication
(10) Pub. No.: US 2011/0074820 A1
(43) Pub. Date: Mar. 31, 2011

(54) INFORMATION DISPLAYING DEVICE AND INFORMATION DISPLAYING METHOD

(75) Inventors: Tohru Nakahara, Osaka (JP); Yasuhiro Yuki, Osaka (JP)

(73) Assignee: PANASONIC CORPORATION, Osaka (JP)

(21) Appl. No.: 12/996,452

(22) PCT Filed: Mar. 3, 2010
(86) PCT No.: PCT/JP2010/001463

§ 371 Date: Dec. 6, 2010

(30) Foreign Application Priority Data
Mar. 27, 2009 (JP) 2009-080098

(51) Int. Cl. G09G 5/377

(52) U.S. Cl. 345/634

(57) ABSTRACT

There are disclosed an information display apparatus and information display method that enable superimposition information to be displayed in such a way that the superimposition information does not interfere with viewing of main screen content. A decision section (2043) decides a superimposition information display format based on a main screen classification of main screen content displayed in the main screen of a display section (205), a characteristic of the superimposition information, and an information amount of the superimposition information, and a display control section (2044) displays superimposition information in a display area corresponding to the main screen classification using the decided display format. Also, when main screen content is switched, the decision section (2043) updates the superimposition information display format after the elapse of a predetermined time after the main screen content has been switched, and the display control section (2044) displays the superimposition information in a display area corresponding to the main screen content after switching, using the display format after updating.

### TECHNICAL FIELD

The present invention relates to an information display apparatus and information display method that display various kinds of information, such as a message, gadget, or the like, superimposed on content.

### BACKGROUND ART

In recent years, systems that distribute content comprising digital copyrighted works such as music, images, games and the like by digital broadcasting, the Internet, and so forth, have been developed, and are reaching the stage of commercialization. At the same time, methods have been studied for displaying various kinds of information, including mail, memos, or suchlike messages, or gadgets displaying weather information, news, and the like, superimposed on such distributed content while that content is being viewed.

With conventional technology, while content is being viewed, various kinds of information, such as messages or gadgets, are displayed so as not to interfere with viewing within a range in which content can be viewed. For example, Patent Literature 1 discloses an information display apparatus that, on receiving an instant message displayed superimposed on content, displays the received instant message in an area away from the center of the main screen.

Citation List

Patent Literature

[PTL 1]

Japanese Translation of a PCT Application Laid-Open No. 2008-510222

### SUMMARY OF INVENTION

### Technical Problem

However, a problem with a conventional information display apparatus is as follows. Namely, with conventional technology, when an information display apparatus performs information display when information arrives or based on a user operation, superimposition information is displayed in a fixed manner in an area away from the center of the main screen irrespective of the detail of content displayed in the main screen (hereinafter referred to as “main screen content”) or the detail of information displayed superimposed on main screen content (hereinafter referred to as “superimposition information”).

Therefore, in a case such as when text information is displayed in other than the center of the screen, as in a news program, there is a problem of superimposition information interfering with content viewing. A further problem is that, when superimposition information is a message announcing an emergency situation, the message is displayed in an area that does not catch the eye.

It is an object of the present invention to provide an information display apparatus and information display method that enable superimposition information to be displayed in such a way that the superimposition information does not interfere with viewing of main screen content.

### Solution to Problem

An information display apparatus of the present invention is an information display apparatus that displays content and superimposition information superimposed on the content in a main screen of a display section, and employs a configuration having: a decision section that decides a first display method of the superimposition information based on a main screen classification of main screen content displayed in the main screen, a characteristic of the superimposition information, and an information amount of the superimposition information; and a control section that displays the superimposition information in a display area corresponding to the main screen classification using the first display method.

An information display method of the present invention is an information display method of an information display apparatus that displays content and superimposition information superimposed on the content in a main screen of a display section, and includes: a decision step of deciding a first display method of the superimposition information based on a main screen classification of main screen content displayed in the main screen, a characteristic of the superimposition information, and an information amount of the superimposition information; and a control step of displaying the superimposition information in a display area corresponding to the main screen classification using the first display method.

### ADVANTAGEOUS EFFECTS OF INVENTION

The present invention enables superimposition information to be displayed in such a way that the superimposition information does not interfere with viewing of main screen content.

### BRIEF DESCRIPTION OF DRAWINGS

FIG. 1 is a drawing showing the overall schematic configuration of an information display system according to an embodiment of the present invention;

FIG. 2 is a block diagram showing the configuration of a content distribution server according to the above embodiment;

FIG. 3 is a block diagram showing the configuration of a terminal apparatus according to the above embodiment;

FIG. 4 is a block diagram showing the configuration of a display information control section according to the above embodiment;

FIG. 5 is a drawing showing the table configuration of a content storage section according to the above embodiment;

FIG. 6 is a drawing showing the table configuration of a content information storage section according to the above embodiment;

FIG. 7 is a drawing showing the table configuration of a superimposition information storage section according to the above embodiment;

FIG. 8 is a drawing showing the table configuration of a display control rule storage section according to the above embodiment;

FIG. 9 is a drawing showing the table configuration of a main screen switching-time display control rule storage section according to the above embodiment;

FIG. 10 is a flowchart showing processing that displays superimposition information;

FIG. 11 is a flowchart showing a superimposition information display format decision process;

FIG. 12 is a drawing showing a main screen at the time of superimposition information display;

FIG. 13 is a flowchart showing a superimposition information update process;

FIG. 14 is a flowchart showing processing that performs a display change at the time of main screen switching; and

FIG. 15 is a drawing showing a main screen after main screen switching.

### DESCRIPTION OF EMBODIMENT

Now, an embodiment of the present invention will be described in detail with reference to the accompanying drawings.

### Embodiment

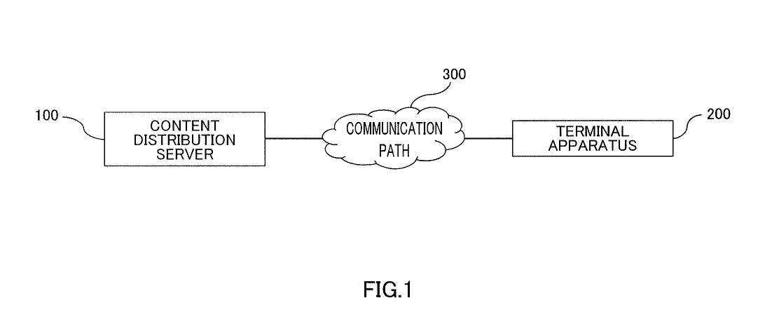

FIG. 1 is a drawing showing the overall schematic configuration of an information display system according to an embodiment of the present invention.

The information display system in FIG. 1 is a system in which content is played back and various kinds of information are displayed by terminal apparatus 200, and includes content distribution server 100 that performs holding and distribution of content, terminal apparatus 200 that acquires and plays back content and displays various kinds of information superimposed on that content, and communication path 300 mutually connecting content distribution server 100 and terminal apparatus 200.

Content distribution server 100 is a server apparatus or broadcasting station facility that has a function for connecting to communication path 300, holds content and content information, and transmits content and content information to terminal apparatus 200. Content distribution server 100 is implemented by a workstation or the like.

Terminal apparatus 200 is an apparatus that has a function for connecting to communication path 300, acquires and holds various kinds of information, such as messages or gadgets, outputs content and various kinds of information to a display or suchlike display section (screen), and performs content playback and information display.

Specifically, terminal apparatus 200 is a data playback apparatus, data recording apparatus, or a device combining these, such as an STB (Set Top Box), digital TV (television), DVD (Digital Versatile Disc) recorder, HDD (Hard Disk Drive) recorder, PC (Personal Computer), PDA (Personal Digital Assistant), mobile phone, or the like, for receiving digital broadcasting.

Communication path 300 is a network that connects content distribution server 100 and terminal apparatus 200 unidirectionally or bidirectionally. Specifically, communication path 300 comprises a broadcast signal from a broadcasting station, a wired network such as Ethernet (registered trademark), a radio network such as a radio LAN (Local Area Network), or a network combining these.

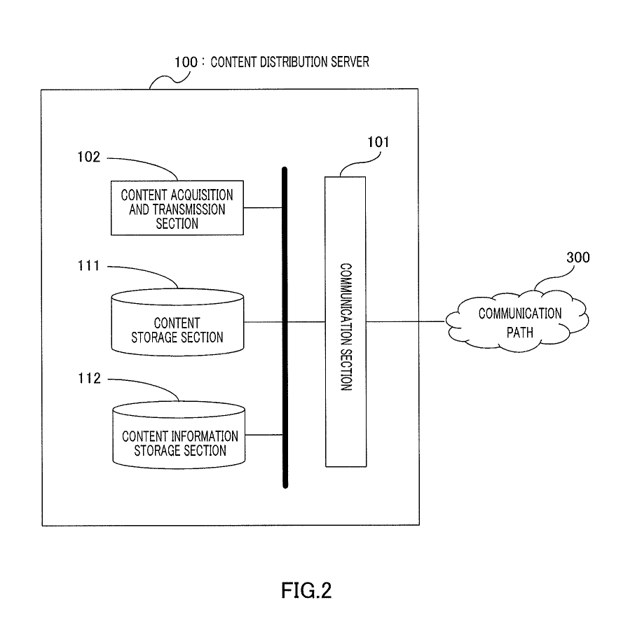

Using FIG. 2 through FIG. 15, this embodiment will specifically describe processing whereby terminal apparatus 200 displays various kinds of information superimposed on main screen content during content display and changes the display method for various kinds of information when main screen content is switched in this kind of information display system.

Definitions of identifiers in this embodiment will now be given.

A content identifier is information for uniquely identifying content in the information display system.

A superimposition information identifier is information for uniquely identifying superimposition information displayed on a display section (screen) of terminal apparatus 200.

A provider identifier is information for uniquely identifying a provider that provides content in the information display system.

Next, the configurations of content distribution server 100 and terminal apparatus 200 will be described in detail.

First, the configuration of content distribution server 100 will be described in detail. FIG. 2 is a block diagram showing the detailed configuration of content distribution server 100.

Content storage section 111 stores content.

Content information storage section 112 stores content information that is information relating to content.

Communication section 101 connects to communication path 300, and performs communication with terminal apparatus 200.

Content acquisition and transmission section 102 acquires content from content storage section 111, acquires content information from content information storage section 112, and transmits the acquired content and content information to terminal apparatus 200.

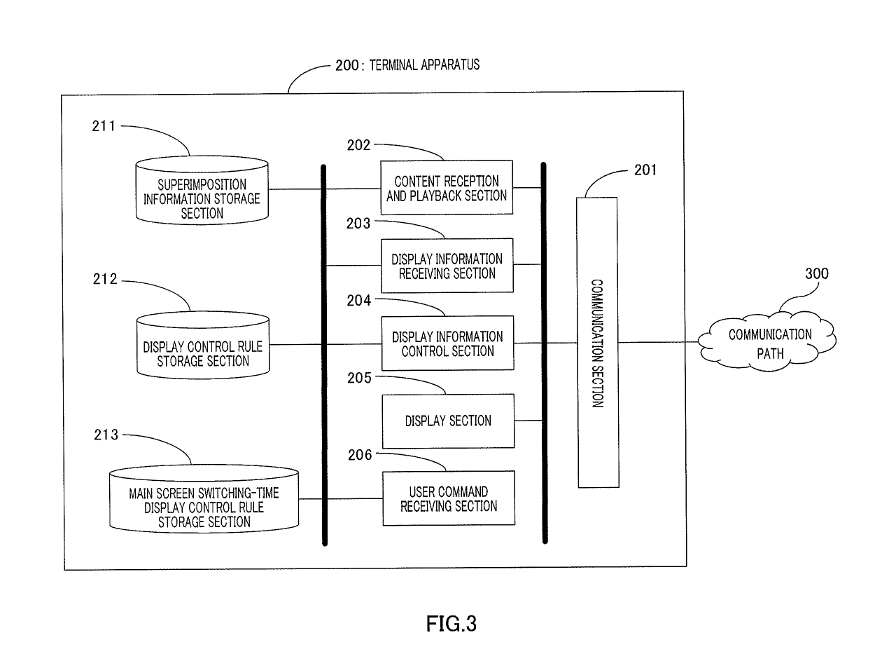

Next, the configuration of terminal apparatus 200 will be described in detail. FIG. 3 is a block diagram showing the detailed configuration of terminal apparatus 200.

Superimposition information storage section 211 stores superimposition information that is displayed superimposed on the main screen of display section 205. Superimposition information is a message, memo, gadget, mail, or the like.

Display control rule storage section 212 stores superimposition information display control rules.

Main screen switching-time display control rule storage section 213 stores superimposition information display control rules in the event of main screen content switching transition of display section 205.

Communication section 201 connects to communication path 300, and performs communication with content distribution server 100 and other terminal apparatuses.

Content reception and playback section 202 receives or acquires and plays back content transmitted from content distribution server 100.

Display information receiving section 203 stores a message input to terminal apparatus 200 via user command receiving section 206, in superimposition information storage section 211. Also, display information receiving section 203 acquires a message sent from an external terminal apparatus via communication section 201, or receives weather or suchlike information. Display information receiving section 203 stores an acquired message or received weather or suchlike information in superimposition information storage section 211.

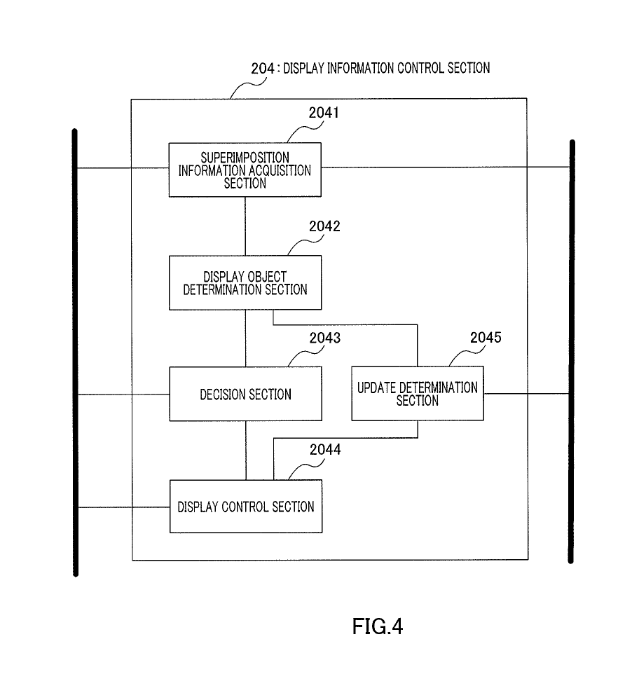

Display information control section 204 controls the display position and display format of superimposition information, and displays superimposition information superimposed on main screen content. FIG. 4 is a block diagram showing the internal configuration of display information control section 204.

Superimposition information acquisition section 2041 acquires superimposition information from superimposition information storage section 211.

Display object determination section 2042 determines the presence or absence of superimposition information to be displayed superimposed on main screen content, based on a superimposition information display condition. In other words, display object determination section 2042 determines superimposition information that is a display object. The determination method used by display object determination section 2042 will be described later herein.

Decision section 2043 acquires a display control rule from display control rule storage section 212 or main screen switching-time display control rule storage section 213, and decides the superimposition information display position and display format based on the acquired display control rule. A method of deciding the display method (display position and display format) in decision section 2043 will be described later herein.

Display control section 2044 displays superimposition information on display section 205 in accordance with the decided display method.

Update determination section 2045 determines whether or not the superimposition information display method is to be updated based on the display condition of the superimposition information determined as the display object. The determination method used by update determination section 2045 will be described later herein.

Returning to FIG. 3 again, display section 205 is a display device such as a plasma display panel or LCD panel (not shown), and displays content and superimposition information.

User command receiving section 206 receives input from a user by a remote controller, direct operation of terminal apparatus 200, or the like. For example, user command receiving section 206 receives input such as a content identifier identifying content, a content acquisition command, superimposition information, a superimposition information display command, and so forth.

This concludes a detailed description of the configurations of content distribution server 100 and terminal apparatus 200.

Of the storage sections and processing sections composing content distribution server 100 and terminal apparatus 200, the storage sections are implemented by storage media such as an HDD or RAM (Random Access Memory), and the processing sections are implemented by programs or the like executed using LSI (Large Scale Integration) or suchlike hardware or a CPU (Central Processing Unit), RAM, ROM (Read Only Memory), or the like. It is desirable for the storage sections and processing sections in terminal apparatus 200 to be made tamper-resistant by hardware or software.

Next, data and data structures handled in this embodiment will be described.

First, details of the storage sections of content distribution server 100, and data held by these storage sections, will be described with reference to the accompanying drawings.

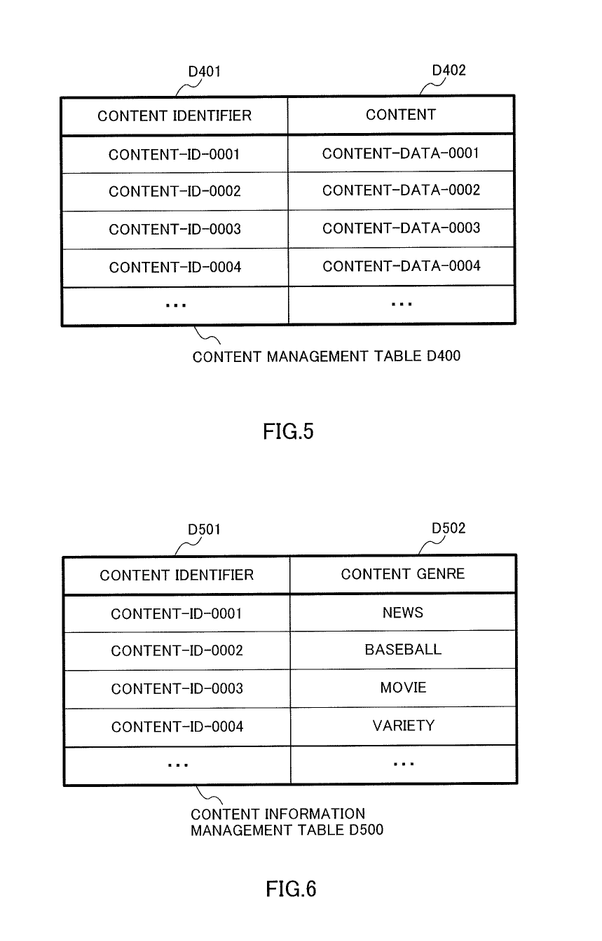

Content storage section 111 is a database that manages content, and is used to acquire content corresponding to a content identifier included in a content distribution schedule or a content acquisition request from terminal apparatus 200. Specifically, as shown in FIG. 5, content storage section 111 has content management table D400 comprising content identifier D401 and content D402 corresponding to content identifier D401.

For example, FIG. 5 shows that content D402 corresponding to “CONTENT-ID-0001” of content identifier D401 is “CONTENT-DATA-0001”. Registration of content and content identifiers in content storage section 111 is performed by a content provider or the like.

Content information storage section 112 is a database that manages content information that is information relating to content, and is used to acquire content corresponding to a content identifier included in a content distribution schedule or a content acquisition request from terminal apparatus 200.

Specifically, as shown in FIG. 6, content information storage section 112 has content information management table D500 in which content identifier D501 and content genre D502 are mutually associated. For example, FIG. 6 shows that when content identifier D501 is “CONTENT-ID-0001”, content genre D502 is “News”. Registration of content information in content information storage section 112 is performed by a content provider or the like.

Content and content information acquired from content storage section 111 and content information storage section 112 are transmitted to terminal apparatus 200.

Next, data held by the storage sections of terminal apparatus 200 will be described with reference to the accompanying drawings.

Superimposition information storage section 211 is a database that manages superimposition information, and is used to acquire superimposition information that is displayed superimposed on main screen content displayed on display section 205 of terminal apparatus 200.

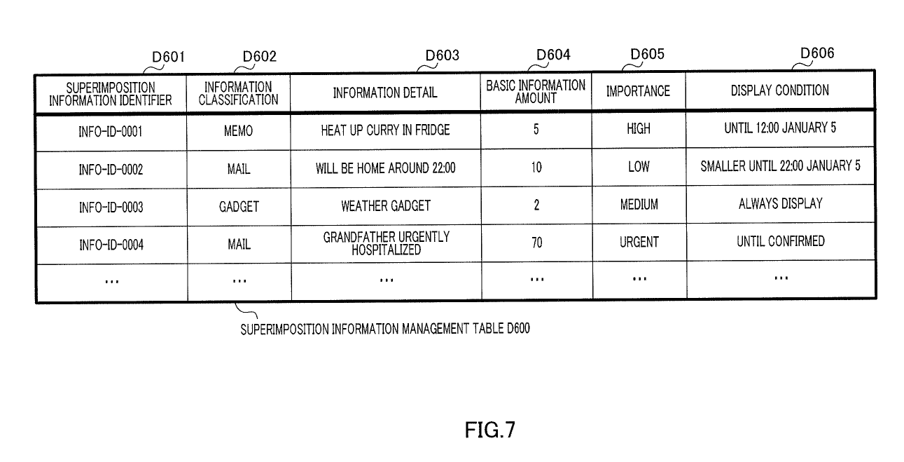

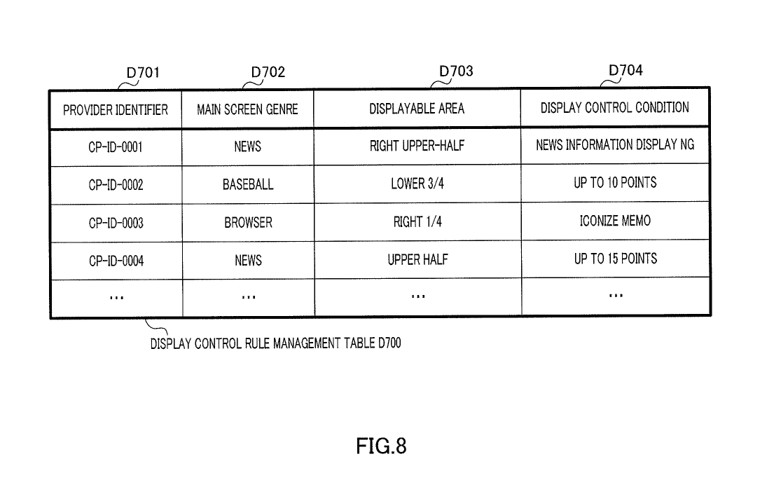

Specifically, as shown in FIG. 7, superimposition information storage section 211 has superimposition information management table D600 in which superimposition information identifier D601, information classification D602 indicating the classification of superimposition information, information detail D603 indicating the detail of superimposition information, basic information amount D604 indicating the initial value of the size of an area in which superimposition information is displayed on the screen, importance D605 indicating the importance of superimposition information, and display condition D606 indicating a superimposition information display condition, are mutually associated.

For example, FIG. 7 shows that when superimposition information identifier D601 is “INFO-ID-0001”, information classification D602 of the superimposition information is “Memo”, information detail D603 are “Heat up curry in fridge”, basic information amount D604 is “5 points”, importance D605 is “High”, and display condition D606 is “Until 12:00 January 5”.

Of the data included in superimposition information management table D600, information classification D602 indicating the classification of superimposition information and importance D605 indicating the importance of superimposition information indicate characteristics of superimposition information. Also, basic information amount D604 indicating the initial value of the size of an area in which superimposition information is displayed indicates the information amount of superimposition information.

A point used as a unit of basic information amount in superimposition information management table D600 indicates an area for which the superimposition information display area size is 1 when the entire screen area of display section 205 is taken to be 100. Therefore, the basic information amount indicates an area occupied by the display of superimposition information. The basic information amount unit is not limited to a point, and any unit may be used as long as it is uniquely decided upon in the information display system.

Data registration in superimposition information storage section 211 is performed by display information receiving section 203 (1) when a message is input to terminal apparatus 200 via user command receiving section 206, (2) when a message, or weather or suchlike information, reported from another terminal via communication section 201 is acquired or received, or (3) when data, or a gadget or suchlike information, acquired from the Internet via a browser or the like is acquired.

Display control rule storage section 212 is a database that manages display control rules, and is used to acquire display control rules that control the display of superimposition information.

Specifically, as shown in FIG. 8, display control rule storage section 212 has display control rule management table D700 in which provider identifier D701 indicating a provider, main screen genre D702 indicating the genre of main screen content, displayable area D703 indicating an area in which superimposition information can be displayed, and display control condition D704 indicating a display control condition for superimposition information corresponding to main screen genre D702, are mutually associated.

For example, FIG. 8 shows that when provider identifier D701 is “CP-ID-0001” and main screen genre D702 is “News”, displayable area D703 is “Right upper-half”, and display control condition D704 is “News information display NG”.

FIG. 8 also shows that even if main screen genre D702 is “News”, when provider identifier D701 is “CP-ID-0004”, unlike the case in which provider identifier D701 is “CP-ID-0001”, displayable area D703 is “Upper-half”, and display control condition D704 is “Display up to 15 points”. Thus, a displayable area or display control condition for displaying superimposition information is decided by a provider identifier or main screen genre. That is to say, a provider identifier or main screen genre can be said to indicate the classification of content displayed in the main screen.

Thus, display control rule storage section 212 manages display control rules according to a main screen content classification. Data registration or updating in display control rule storage section 212 is performed by pre-registration upon shipping terminal apparatus 200, or reception via communication section 201 from a provider device, another terminal, or the like. Since display control rule registration or updating can be performed via communication section 201, flexible display control by a provider, terminal manufacturer, or the like, is possible.

In this embodiment, display control rules have been described as being set by a provider for each content genre, but display control rules common to all providers may also be set, or display control rules may be set for each classification other than content genre, for instance.

In the above description, display control rules have been described as being set from a provider's viewpoint, but provision may also be made for settings to be made from a user's viewpoint so as to provide good visibility for the user himself. In this case, a provider may provide a user with items for which setting is permitted and items for which setting is not permitted. For example, a displayable area may be designated as a user-settable item, while a display control condition is designated as a non-user-settable item.

Main screen switching-time display control rule storage section 213 is a database that manages display control rules in the event of main screen switching, and is used to acquire display control rules that control a superimposition information display method when main screen content is switched at the time of superimposition information display.

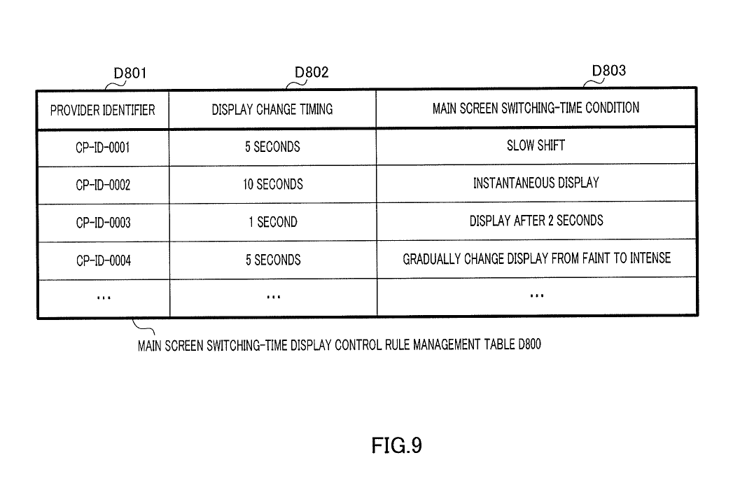

Specifically, as shown in FIG. 9, main screen switching-time display control rule storage section 213 has main screen switching-time display control rule management table D800 comprising provider identifier D801 indicating a provider that provides main screen content, display change timing D802 indicating a predetermined time until which a superimposition information display method is to be changed after a transition of main screen content to switched-to content, and main screen switching-time condition D803 indicating a control condition when a superimposition information display method is changed.

For example, FIG. 9 shows that when provider identifier D801 is “CP-ID-0001”, display change timing D802 is “5 seconds”, and main screen switching-time condition D803 is “Slow shift”.

Registration or updating of display control rules in main screen switching-time display control rule storage section 213 is performed by pre-registration upon shipping terminal apparatus 200, or reception via communication section 201 from a provider device, another terminal, or the like. Display control rule registration and updating via communication section 201 makes flexible display control possible by a provider, terminal manufacturer, or the like.

In this embodiment, a case has been described by way of example in which display control rules are set on a provider-by-provider basis, but display control rules common to all providers may also be set, or display control rules may be set on a classification-by-classification basis, such as for each content genre. Also, in the above description, a case has been described in which display control rules have been described as being set from a provider's viewpoint, but provision may also be made for display control rules to be set from a user's viewpoint so as to provide good visibility for the user himself.

This concludes a description of data and data structures handled in this embodiment.

Next, processing will be described that is necessary for terminal apparatus 200, on receiving content in the information display system, to [1] play back content in the main screen while displaying superimposition information superimposed on the main screen content, and [2] change a superimposition information display method when main screen content switching is performed at the time of superimposition information display.

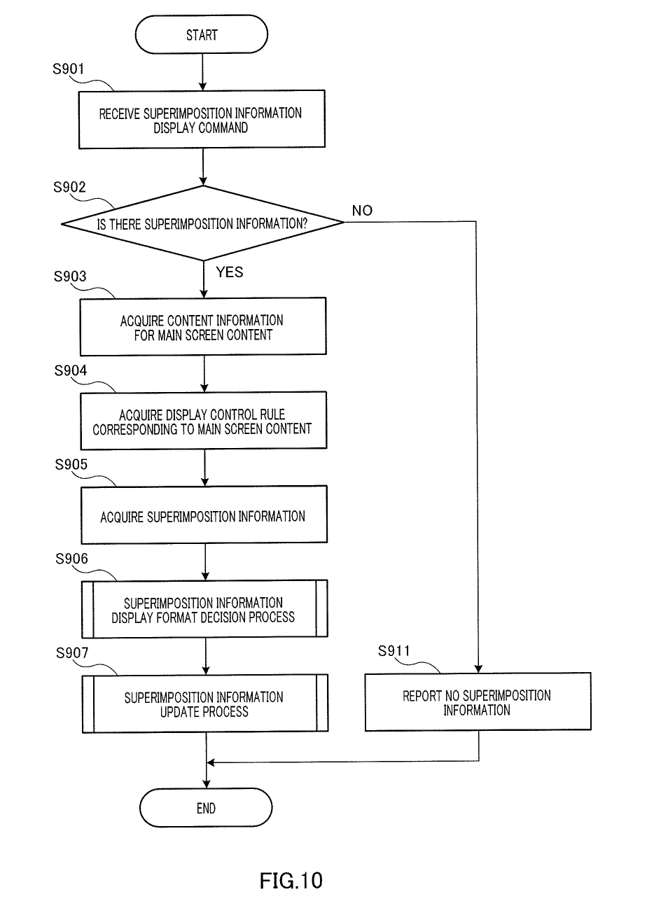

In order to implement processing [1] and [2] above, terminal apparatus 200 requires (1) superimposition information acquisition and storage processing, (2) content reception and display processing, (3) superimposition information display processing, and (4) superimposition information display change processing at the time of main screen content switching. Processing (1) through (4) above will now be described with reference to FIG. 10 through FIG. 15.

(1) Superimposition Information Acquisition and Storage Processing

First, a description will be given of processing by various sections when display information receiving section 203 of terminal apparatus 200 acquires superimposition information, and stores this information in superimposition information storage section 211.

In response to input of a message or suchlike information and a data acquisition command from a user, display information receiving section 203 starts superimposition information acquisition and storage processing. The user inputs information specifying a message to be displayed superimposed on main screen content as superimposition information, or data to be acquired, to a terminal apparatus 200 application via user command receiving section 206.

User command receiving section 206 receives input from the user, and display information receiving section 203 acquires an input message or suchlike information as superimposition information. Alternatively, display information receiving section 203 acquires superimposition information based on information specifying input data. Display information receiving section 203 assigns a superimposition information identifier to the acquired superimposition information, and stores this information in superimposition information storage section 211 together with a corresponding information classification, importance, display condition, and so forth.

For example, if a mother leaving the house on the morning of a holiday leaves the memo “Heat up curry in fridge” for her child who is still sleeping, user command receiving section 206 inputs “Memo” as the information classification, “High” as importance, “Display until 12:00 January 5” as a display condition, and so forth. Also, display information receiving section 203 automatically calculates the basic information amount of these items of superimposition information.

In this way, display information receiving section 203 of terminal apparatus 200 stores superimposition information, superimposition information characteristics such as information classification and importance, a basic information amount, and a display condition in superimposition information storage section 211 in a mutually associated form.

Provision may also be made for user command receiving section 206 to simplify information input by a template or multiple-choice format, or to present a superimposition information display image to the user, and for the user to be able to change the information amount, display condition, or the like of superimposition information.

Also, when the user specifies a gadget to be acquired as superimposition information by user command receiving section 206, as in the case of a weather gadget, provision may be made for display information receiving section 203 to acquire a weather gadget and store it in superimposition information storage section 211 automatically. When display information receiving section 203 acquires gadget information, it does not acquire a gadget itself, but data automatically acquired by the gadget, and stores this in superimposition information storage section 211.

In the above description, a case has been described in which a user directly inputs a message or information specifying data to user command receiving section 206, but display information receiving section 203 can also store superimposition information in superimposition information storage section 211 using the same kind of method when receiving mail or suchlike superimposition information sent from another terminal.

In this case, display information receiving section 203 sets superimposition information characteristics such as information classification and importance by estimating them from the detail of mail as well as through specification by the sender of the mail, or by assigning them automatically based on existing information such as sender information, for instance. There are various conceivable superimposition information acquisition and superimposition information characteristic setting methods, but these are not essential to the present invention, and therefore a detailed description of other methods is omitted here.

In the above-described way, display information receiving section 203 acquires superimposition information, and stores it in superimposition information storage section 211 associated with characteristics and a display condition for that superimposition information.

(2) Content Reception and Display Processing

Next, a description will be given of processing by various sections when content reception and playback section 202 of terminal apparatus 200 receives content from content distribution server 100 and displays this information on display section 205.

In response to information input and a content acquisition command from a user, content reception and playback section 202 starts content acquisition processing. The user inputs a content identifier or information based on a content identifier to an application of terminal apparatus 200 via user command receiving section 206. A case is described below by way of example in which the user inputs content identifier “CONTENT-ID-0001”, and content reception and playback section 202 starts content acquisition processing.

When user command receiving section 206 receives input from the user, content reception and playback section 202 generates a content acquisition request message that includes a content identifier, and transmits the generated content acquisition request message to content distribution server 100 via communication section 201.

Content distribution server 100 receives the content acquisition request message via communication section 101. Next, content acquisition and transmission section 102 extracts content identifier “CONTENT-ID-0001” from the content acquisition request message, and acquires corresponding content “CONTENT-DATA-0001” and content genre “News” from content storage section 111 and content information storage section 112.

Then content acquisition and transmission section 102 generates a content transmission message that includes the acquired content, content genre, and provider identifier “CP-ID-0001”, and transmits the generated content transmission message to terminal apparatus 200 via communication section 101.

On receiving the content transmission message via communication section 201, content reception and playback section 202 of terminal apparatus 200 displays the received content in the main screen of display section 205. Also, content reception and playback section 202 stores the content genre and provider identifier as information relating to the content being displayed.

As an example of content acquisition and playback, a case has here been described in which content distribution server 100 performs on-demand distribution via the Internet, but if content distribution server 100 is a broadcasting station, content distribution server 100 may extract a content identifier from a distribution schedule or the like, multiplex the corresponding content, content genre, and provider identifier, and distribute these as a broadcast wave. There are various conceivable content, content genre, and provider identifier distribution methods and operations, but these are not essential to the present invention, and therefore a detailed description thereof is omitted here.

When a user switches viewed content, the above processing is performed for each content after switching.

In the above-described way, content reception and playback section 202 acquires content from content distribution server 100 in response to a content acquisition request from a user, and displays the acquired content in the main screen of display section 205.

(3) Superimposition Information Display Processing

Next, a description will be given, with reference to FIG. 10, of processing by various sections until display information control section 204 of terminal apparatus 200 displays superimposition information stored in superimposition information storage section 211 superimposed on main screen content.

Display information control section 204 starts superimposition information display processing in response to a superimposition information display command from a user (step S901). The user inputs a superimposition information display command via user command receiving section 206 by a user remote operation or the like.

First, display object determination section 2042 of display information control section 204 confirms the presence or absence of superimposition information that is a display object from superimposition information storage section 211, and determines whether or not display processing is necessary (step S902). As shown in FIG. 7, display conditions such as a period indicating superimposition information are included in superimposition information management table D600 stored in superimposition information storage section 211.

For example, when superimposition information identifier D601 is “INFO-ID-0001”, display condition D606 is “Until 12:00 January 5”. In this case, display object determination section 2042 acquires the current time, and determines that there is superimposition information that is a display object if the current time is included in the display condition period, or determines that there is no superimposition information that is a display object if the current time is not included in the display condition period.

Display object determination section 2042 performs the above determination for all superimposition information stored in superimposition information management table D600 of superimposition information storage section 211. Next, if there is even one item complying with the display condition, display object determination section 2042 determines that there is superimposition information that is a display object, and that display processing is necessary (step S902: YES). On the other hand, if there is no item complying with the display condition, display object determination section 2042 determines that there is no superimposition information that is a display object, and that display processing is unnecessary (step S902: NO).

There are assumed to be various other display conditions, such as “Until message detail can be confirmed”, “If it is raining”, “If user who gave display command is father”, “Information for daughter”, and so forth. Display object determination section 2042 acquires information required for determining respective display conditions from inside and outside the terminal apparatus, and determines the presence or absence of superimposition information that is a display object. Display condition items are not limited to these.

In the event of determining that display processing is unnecessary (step S902: NO), display object determination section 2042 notifies the user that there is no superimposition information that is a display object, and terminates the processing (step S911). Provision may also be made for display object determination section 2042 to include a reason for the absence of superimposition information that is a display object in the notification—for example, information such as “There are no messages for father”, or “There is no information for display today”.

If display object determination section 2042 determines that display processing is necessary (step S902: YES), decision section 2043 acquires content information corresponding to main screen content from content reception and playback section 202 (step S903). Specifically, if content having content identifier “CONTENT-ID-0002” is being viewed, decision section 2043 acquires provider identifier “CP-ID-0002” and content genre “Baseball” corresponding to content identifier “CONTENT-ID-0002”. Below, a case is described by way of example in which display information control section 204 receives a superimposition information display command while the user is viewing content having content identifier “CONTENT-ID-0002”.

Decision section 2043 identifies and acquires a display control rule corresponding to main screen content from display control rule storage section 212 using a provider identifier and content genre acquired from content reception and playback section 202 as keys (step S904). Specifically, decision section 2043 identifies a display control rule using provider identifier “CP-ID-0002” and content genre “Baseball” corresponding to main screen content (content identifier “CONTENT-ID-0002”) as keys, and acquires displayable area “Lower ¾” and display control condition “Display information amount up to 10 points”.

Superimposition information acquisition section 2041 acquires superimposition information for which display processing was determined to be necessary in step S902 from superimposition information storage section 211 (step S905).

Decision section 2043 executes a superimposition information display format decision process (step S906). The superimposition information display format decision process will be described later herein.

Display control section 2044 executes a superimposition information update process (step S907) and terminates superimposition information display processing. The superimposition information update process will be described later herein.

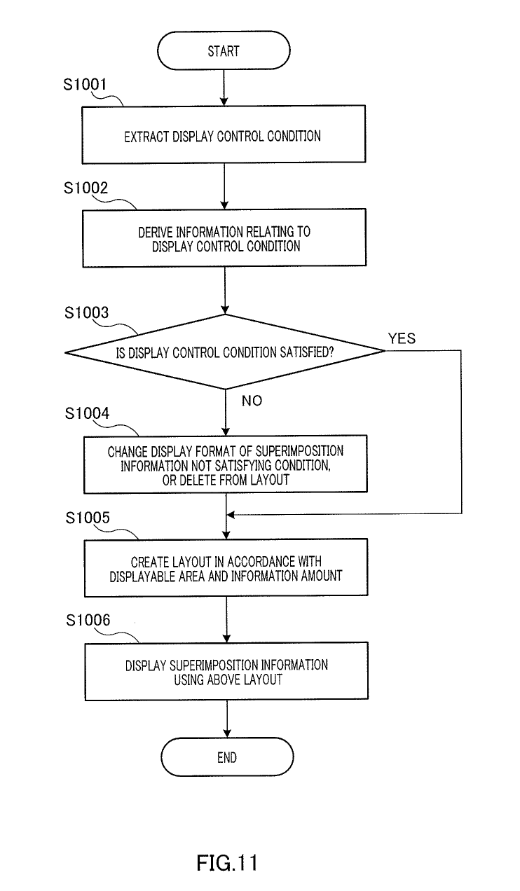

The superimposition information display format decision process in step S906 in FIG. 10 will now be described with reference to the flowchart in FIG. 11.

Decision section 2043 extracts a display control condition corresponding to the main screen classification from the display control rule acquired in step S904 (step S1001), and acquires a parameter relating to the extracted display control condition or related information (step S1002).

Specifically, decision section 2043 acquires the information “Display information amount up to 10 points” that is a display control condition corresponding to provider identifier “CP-ID-0002” and content genre “Baseball”. Next, decision section 2043 acquires a display information amount of each item of superimposition information necessary for confirmation of satisfaction of the display control condition. For example, if it was determined by display object determination section 2042 in step S902 that 3 lines of superimposition information from the top of FIG. 7 need to be display objects, decision section 2043 acquires “5 points”, “10 points”, and “2 points”.

Then, based on a parameter or related information acquired in step S1002, decision section 2043 determines whether or not the information detail and basic information amount of superimposition information satisfy the display control condition (step S1003).

If the information detail and basic information amount of superimposition information satisfy the display control condition (step S1003: YES), decision section 2043 does not perform step S1004, but proceeds to the processing in step S1005 described later herein.

On the other hand, if the information detail and basic information amount of superimposition information do not satisfy the display control condition (step S1003: NO), decision section 2043 changes the basic information amount of superimposition information that does not satisfy the display control condition, or excludes superimposition information that does not satisfy the display control condition from display objects, and deletes it from the display layout (step S1004).

Specifically, when the display control condition is “Display information amount up to 10 points”, and the total of basic information amounts “5 points”, “10 points”, and “2 points” of superimposition information determined to be display objects is 17 points, the display control condition is not satisfied. In this case, based on the importance of each item of superimposition information, decision section 2043 performs display format modification or processing for exclusion from the display objects, starting from superimposition information of low importance (step S1004).

When laying out 3 lines of superimposition information from the top of FIG. 7, decision section 2043 decides, for example, that low-importance superimposition information having superimposition information identifier “INFO-ID-0002” is to be displayed as an icon. Making superimposition information having superimposition information identifier “INFO-ID-0002” an icon enables the basic information amount to be changed from “10 points” to “3 points”, as a result of which the total of the three basic information amounts becomes 10 points, and the display control condition can be satisfied.

Thus, decision section 2043 changes the superimposition information display format, or selects superimposition information to be excluded from the display objects and decides the display format of the selected superimposition information to be “non-display”, based on superimposition information characteristics and basic information amounts, so as to satisfy a display control condition corresponding to a main screen classification.

Provision may also be made for decision section 2043 to include a display information amount reduction method such as “Iconize information detail of low importance” or “Delete information detail of low importance” in display control conditions beforehand. Also, if there is a plurality of mail from the same sender in the case of the display control condition “Do not display information duplicating other information, or information for which there is an update”, provision may be made for decision section 2043 to decide to exclude mail other than the latest mail from display objects, and to display only the latest mail. Furthermore, in the case of the display control condition “News information display NG”, provision may be made for display object determination section 2042 to determine whether or not superimposition information is to be made a display object in step S902 based on the information classification and information detail of superimposition information.

Display control section 2044 creates and displays a superimposition information layout for which the display format and display objects have been changed as necessary by decision section 2043 in a displayable area in accordance with a main screen content provider identifier and main screen genre—that is, main screen classification (step S1005).

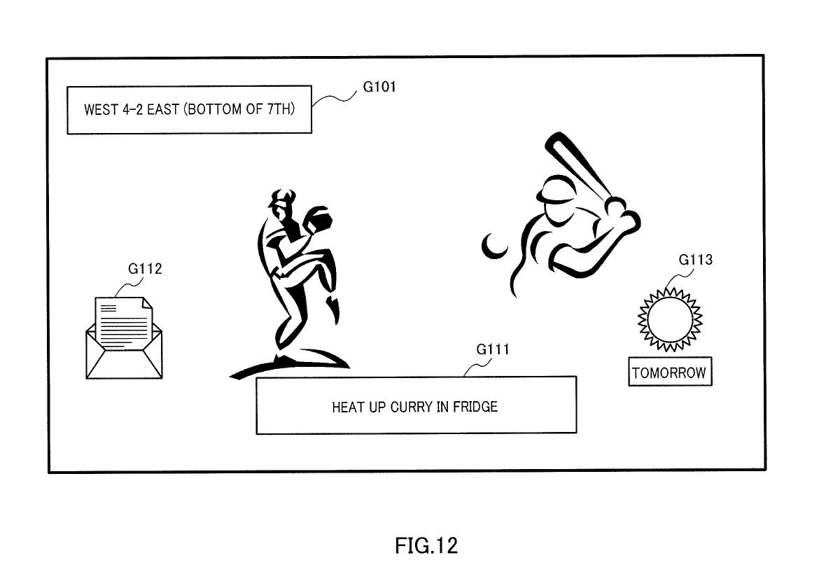

FIG. 12 is a drawing showing a sample layout of 3 lines of superimposition information from the top of FIG. 7. FIG. 12 shows an example of a case in which the main screen content provider identifier is “CP-ID-0002”, and the main screen genre is “Baseball”. In order for baseball score G101 to be constantly displayed during viewing of this main screen content, the displayable area for superimposition information has been set as “Lower ¾” as a display control condition (see FIG. 8). In the example shown in FIG. 12, information detail having superimposition information identifiers “INFO-ID-0001” and “INFO-ID-0003” are displayed as memo display G111 and gadget display G113 with the basic information amount unchanged, superimposition information identifier “INFO-ID-0002” has been iconized, and is displayed as icon G112 with the basic information amount changed.

Provision may also be made for the layout, including superimposition information display position, color depth, coloration, and so forth, to be user-settable.

Display control section 2044 displays superimposition information using a layout in accordance with a displayable area and information amount (step S1006).

In the above-described way, decision section 2043 executes a superimposition information display format decision process.

In the above description, a case has been described by way of example in which decision section 2043 applies restrictions to a superimposition information display format based on a display control condition corresponding to a main screen classification. Here, if superimposition information requires urgency, provision may be made for a display control condition to be ignored, and for display control section 2044 to display superimposition information in a suitable format. For example, display control section 2044 may exceptionally display the message “Grandfather urgently hospitalized” requiring urgency in large format in the center of the screen, ignoring the display control condition.

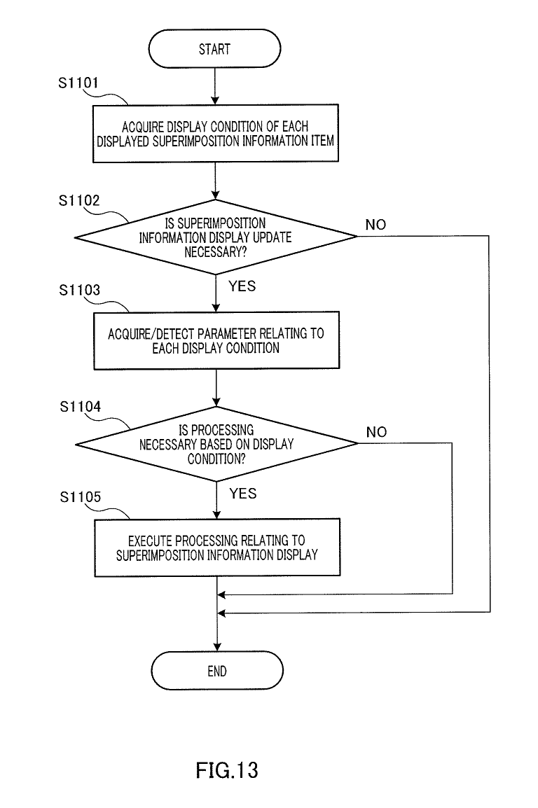

The superimposition information update process in step S907 in FIG. 10 will now be described with reference to the flowchart in FIG. 13.

Update determination section 2045 extracts a display condition of each item of superimposition information determined to be a display object in step S906 (step S1101), and determines whether or not the superimposition information display method is to be updated based on changing circumstances (step S1102). Specifically, when “Smaller until 22:00 January 5” or “Always display” is extracted, update determination section 2045 determines that display updating/deletion is necessary in the former case because it is necessary to perform a smaller display with time, but determines that display updating/deletion is unnecessary in the latter case.

In the event of determining that superimposition information display updating is unnecessary (step S1102: NO), update determination section 2045 terminates the superimposition information update process (step S907).

On the other hand, in the event of determining that superimposition information display updating is necessary (step S1102: YES), update determination section 2045 acquires a parameter relating to a display condition or related information (step S1103). An actual example of related parameter or related information acquisition is omitted here since the process is similar to that in step S1102.

Based on a parameter or related information acquired in step S1103 and a display condition, update determination section 2045 determines whether or not processing for superimposition information display updating or deletion is necessary under the present circumstances (step S1104). If update/deletion processing is necessary, update determination section 2045 performs superimposition information display update/deletion processing (step S1105).

Specifically, when the display condition is “Until 12:00 January 5”, if the current time is 11:00, update determination section 2045 determines that update/deletion processing is unnecessary, and display control section 2044 does not perform update/deletion processing. On the other hand, if the current time is 12:00, update determination section 2045 determines that update/deletion processing is necessary, and display control section 2044 performs update/deletion processing.

Thus, when detection of a predetermined time or update trigger “until user confirmation” is necessary, a predetermined time or user operation is set as a detection condition in an update trigger detection section (not shown), and corresponding display updating is performed at the time of trigger detection.

Also, when it is necessary to change the display continually with the passage of time, as in the case of the display condition “Smaller until 22:00 January 5”, display control section 2044 can implement this by performing predetermined display update processing at intervals of several tens of seconds, or by performing polling to confirm processing detail. When the superimposition information display size is reduced or increased according to time or according to a user operation or the like, in order to reduce shifting of the user's viewpoint, display control section 2044 may perform enlargement or reduction with a fixed superimposition information center point, center line, and frame edge, for instance.

Updating of displayed superimposition information such as described above is particularly effective for displaying information whose importance decreases with the passage of time, or displaying information whose importance increases with the passage of time. For example, message mail such as “Will be home at 22:00” becomes of less importance as the time for returning home, 22:00, approaches, and can therefore be displayed in a smaller size as 22:00 approaches. Conversely, a weather gadget such as “Today's forecast: Rain” increases in importance as a departure time approaches, and can therefore be displayed in a larger size as the departure time approaches.

In the above-described way, update determination section 2045 and display control section 2044 execute a superimposition information update process.

In the above-described way, after receiving a superimposition information display command, display information control section 204 displays superimposition information stored in superimposition information storage section 211 superimposed on main screen content.

(4) Superimposition Information Display Change Processing at the Time of Main Screen Content Switching

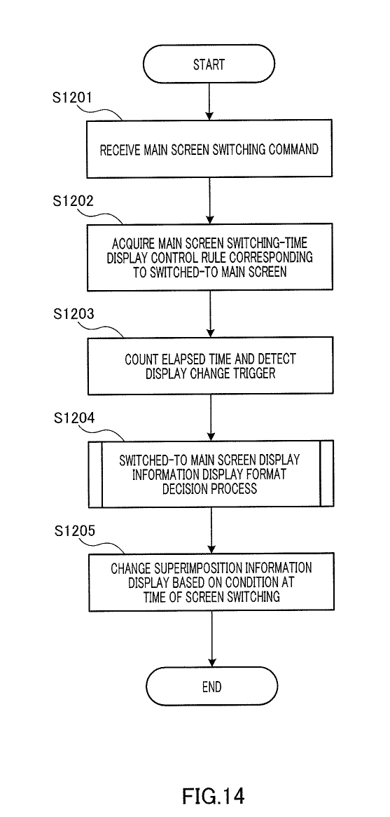

Lastly, a description will be given, with reference to FIG. 14, of processing by various sections from reception by display information control section 204 of terminal apparatus 200 of a main screen switching command at the time of superimposition information display, until display information control section 204 changes the superimposition information display position and display format to a display method suitable for main screen content that is switched to.

Display information control section 204 starts superimposition information display change processing at the time of main screen content switching in response to a main screen switching command from a user at the time of superimposition information display (step S1201). The user inputs a main screen switching command via user command receiving section 206 by a user remote operation or the like.

Decision section 2043 acquires a provider identifier corresponding to switched-to content from content reception and playback section 202, and identifies and acquires display change timing and a main screen display switching condition from main screen switching-time display control rule storage section 213 using the provider identifier as a key (step S1202).

Decision section 2043 counts the time from transition of the main screen content to the switched-to content by a timer, and when the count value reaches the display change timing, performs the following display change processing (step S1203). For example, if the display change timing is “5 seconds”, the superimposition information display method is not changed until superimposition information has been displayed for 5 seconds using the same display method as before the switch.

By this means, even if the user is performing zapping viewing, the superimposition information display method does not change with dizzying rapidity, but is switched after the user has reached a state in which he is viewing the main screen content placidly.

Display object determination section 2042 and decision section 2043 apply the previously described superimposition information display format decision process to main screen content for which the display change timing has been reached, determine a display object, and decide a display format (step S1204).

Display control section 2044 displays superimposition information in a display area corresponding to the classification of the switched-to content based on a main screen switching-time condition (step S1205).

Specifically, when the main screen switching-time condition is “Slow shift”, during zapping, display control section 2044 continues to display superimposition information using the same display method as before zapping. Then, when zapping ends and a predetermined time indicated by the display change timing has elapsed, display control section 2044 slowly slides the superimposition information from the pre-zapping display method to a new display method suitable for the switched-to main screen content.

Provision may also be made for display control section 2044 not to display superimposition information during zapping, but to display superimposition information using a new method suitable for the switched-to main screen content after a predetermined time has elapsed. Provision may also be made for display control section 2044 to make the color of superimposition information lighter, or make the display size smaller, during zapping.

As an example, a description will be given of updating of displayed superimposition information when main screen content is switched from a state in which the superimposition information shown in FIG. 12 is being displayed to provider identifier “CP-ID-0002” content genre “News”.

As shown in FIG. 7, the basic information amounts of superimposition information being displayed superimposed on main screen content in FIG. 12 are “5 points”, “10 points”, and “2 points”, and the total basic information amount is “17 points”. Here, a display control condition corresponding to provider identifier “CP-ID-0002” and main screen genre “News” of switched-to content is “17 points”.

Therefore, the total basic information amount of superimposition information satisfies the display control condition. That is to say, the display control condition is satisfied in confirmation of display control condition satisfaction (step S1003) in the superimposition information display format decision process (step S1204) of the flow of superimposition information display change processing at the time of main screen content switching.

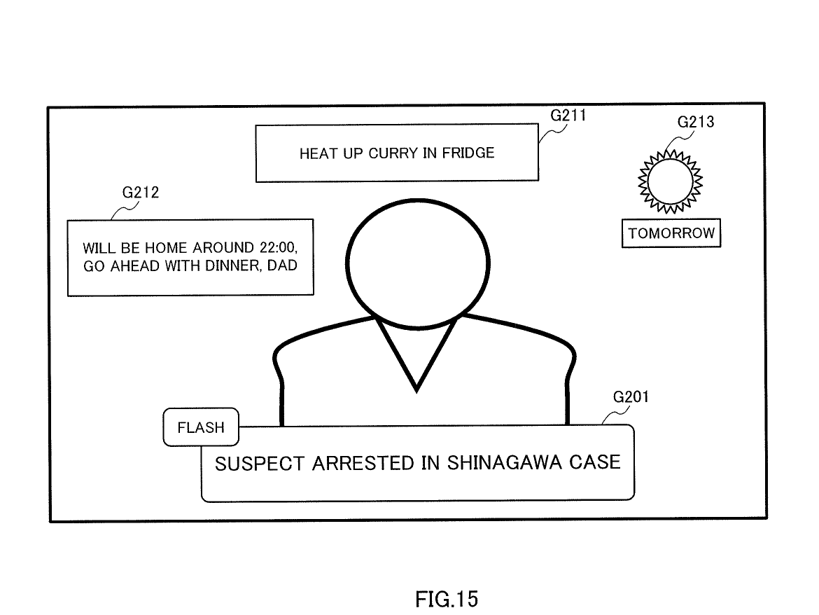

Consequently, after main screen content switching, display of the basic information amount of superimposition information is possible without change. FIG. 15 is a drawing showing an example of a superimposition information layout after main screen content switching. As shown in FIG. 15, message mail “Will be home around 22:00” being displayed by icon G112 before the switch, has been changed to message display G212.

Also, since the displayable area for main screen content after switching is “Upper half”, information detail “Heat up curry in fridge” have their display position changed from memo display G111 to memo display G211, and information detail “Weather gadget” have their display position changed from gadget display G113 to gadget display G213.

By such display position changes, display control section 2044 can perform display in such a way that superimposition information is not superimposed on news program telop G201, enabling superimposition information to be displayed without interfering with the viewing of main screen content.

When changing the display size of superimposition information, display control section 2044 may perform enlargement with a fixed superimposition information center point, center line, and frame edge, as explained in the previously described superimposition information update process. Also, for a similar reason, when changing the display position of superimposition information, display control section 2044 may move the display position with a fixed superimposition information center point, center line, and frame edge.

In the above-described way, in the event of receiving a main screen switching command at the time of superimposition information display, display information control section 204 displays superimposition information after changing to a display method suitable for switched-to main screen content.

As described above, by performing (1) superimposition information acquisition and storage processing, (2) content reception and display processing, and (3) superimposition information display processing, terminal apparatus 200 can better avoid interference with main screen content viewing while displaying superimposition information using a suitable information amount, display position, and display format according to a main screen classification, superimposition information characteristics, and basic information amount of superimposition information, without the need for a user operation each time main screen content switching is performed.

Also, by performing (4) superimposition information display change processing as described above at the time of main screen switching, terminal apparatus 200 can perform a suitable display change without a dizzyingly rapid change of superimposition information display, even when a user is performing channel zapping or the like.

In the above description, a case has been described in which some kind of content is being played back in the main screen, but the present invention can also be applied when content is not being played back in the main screen, or when something other than content is being played back in the main screen, such as when browsing by a Web browser in a digital TV is being displayed in the main screen.

For example, when nothing is being played back in the main screen, display information control section 204 can display superimposition information arbitrarily in the main screen area without restrictions, with the displayable area as “Entire area”, and a display control condition as “Nothing in particular”.

The disclosure of Japanese Patent Application No. 2009-080098, filed on Mar. 27, 2009, including the specification, drawings and abstract, is incorporated herein by reference in its entirety.

### INDUSTRIAL APPLICABILITY

The present invention is suitable for use as a content distribution service receiving terminal using package media such as DVDs, a content display terminal using digital broadcasting, CATV, the Internet, or the like, and so forth.

### REFERENCE SIGNS LIST

100 Content distribution server

101, 201 Communication section

102 Content acquisition and transmission section

111 Content storage section

112 Content information storage section

200 Terminal apparatus

202 Content reception and playback section

203 Display information receiving section

204 Display information control section

2041 Superimposition information acquisition section

2042 Display object determination section

2043 Decision section

2044 Display control section

2045 Update determination section

205 Display section

206 User command receiving section

211 Superimposition information storage section

212 Display control rule storage section

213 Main screen switching-time display control rule storage section

300 Communication path

1-16. (canceled)

17. An information display apparatus that displays content and superimposition information superimposed on the content in a main screen of a display section, the information display apparatus comprising:
a decision section that decides a first display method of the superimposition information, and a second display method different from the first display method, used when a predetermined time has elapsed after the main screen content has been switched, based on a main screen classification of main screen content displayed in the main screen, a characteristic of the superimposition information, and an information amount of the superimposition information; and
a control section that displays the superimposition information in a display area corresponding to the main screen classification using the first display method, and, when a predetermined time has elapsed after the main screen content has been switched, displays the superimposition information in a display area corresponding to the main screen classification of the main screen content after switching using the second display method.

18. The information display apparatus according to claim 17, wherein the main screen classification is a provider that provides the main screen content or a genre of the main screen content.

19. The information display apparatus according to claim 17, wherein a characteristic of the superimposition information is information contents or importance of the superimposition information.

20. The information display apparatus according to claim 17, wherein:
the decision section decides a third display method different from the first display method and the second display method, used during an elapse of a predetermined time after the main screen content has been switched; and
the control section displays the main screen content after the switching, using the third display method during an elapse of a predetermined time after the main screen content has been switched.

21. The information display apparatus according to claim 20, wherein the third display method is a display method whereby the superimposition information is moved, while being displayed, from a first display position decided by means of the first display method to a second display position decided by means of the second display method.

22. The information display apparatus according to claim 20, wherein the third display method is a display method whereby a color shade of the superimposition information decided by means of the first display method and the second display method is changed.

23. The information display apparatus according to claim 20, wherein the third display method is a display method whereby a size of the superimposition information is changed without changing a center position of the superimposition information decided by means of the first display method and the second display method.

24. An information display method that is an information display method of an information display apparatus that displays content and superimposition information superimposed on the content in the main screen of a display section, the information display method comprising:
a decision step of deciding a first display method of the superimposition information, and a second display method different from the first display method, used when a predetermined time has elapsed after the main screen content has been switched, based on a main screen classification of main screen content displayed in the main screen, a characteristic of the superimposition information, and an information amount of the superimposition information; and
a control step of displaying the superimposition information in a display area corresponding to the main screen classification using the first display method, and, when a predetermined time has elapsed after the main screen content has been switched, displaying the superimposition information in a display area corresponding to the main screen classification of the main screen content after switching using the second display method.

25. The information display method according to claim 24, wherein the main screen classification is a provider that provides the main screen content or a genre of the main screen content.

26. The information display method according to claim 24, wherein a characteristic of the superimposition information is information contents or importance of the superimposition information.

27. The information display method according to claim 24, wherein:
the decision step decides a third display method different from the first display method and the second display method, used during an elapse of a predetermined time after the main screen content has been switched; and
the control step displays the main screen content after the switching, using the third display method during an elapse of a predetermined time after the main screen content has been switched.

28. The information display method according to claim 27, wherein the third display method is a display method whereby the superimposition information is moved, while being displayed, from a first display position decided by means of the first display method to a second display position decided by means of the second display method.

29. The information display method according to claim 27, wherein the third display method is a display method whereby a color shade of the superimposition information decided by means of the first display method and the second display method is changed.

30. The information display method according to claim 27, wherein the third display method is a display method whereby a size of the superimposition information is changed without changing a center position of the superimposition information decided by means of the first display method and the second display method.
